(19) United States
(12) Patent Application Publication
(10) Pub. No.: US 2025/0280401 A1
(43) Pub. Date: Sep. 4, 2025

(54) SRS ENHANCEMENT FOR MULTI-TRP COHERENT JOINT TRANSMISSION OPERATION

(71) Applicant: APPLE INC., Cupertino, CA (US)

(72) Inventors: Haitong Sun, Cupertino, CA (US); Huaning Niu, San Jose, CA (US); Hong He, San Jose, CA (US); Chunxuan Ye, San Diego, CA (US); Dawei Zhang, Saratoga, CA (US); Wei Zeng, San Diego, CA (US); Jie Cui, San Jose, CA (US); Yushu Zhang, Beijing (CN)

(21) Appl. No.: 18/859,228

(22) PCT Filed: Apr. 28, 2023
(86) PCT No.: PCT/US2023/066333

§ 371 Date: Oct. 23, 2024

Related U.S. Application Data
(60) Provisional application No. 63/363,813, filed on Apr. 29, 2022.

(51) Int. Cl. H04W 72/0453; H04L 5/00; H04W 72/231; H04W 76/20

(52) U.S. Cl. CPC H04W 72/0453; H04L 5/001; H04L 5/0051; H04W 72/231; H04W 76/20

(57) ABSTRACT

In cellular wireless communications, sounding reference signals (SRS) may be used to estimate uplink channel quality. A wireless communication device or mobile device (i.e., UE) can transmit an SRS to a base station (e.g., eNB for LTE and gNB for NR). SRS gives information about the combined effect of multipath fading, scattering, Doppler and power loss of transmitted signal. A number of enhancements may be introduced to the SRS for Multi-TRP Coherent Joint transmission.

### TECHNICAL FIELD

This application relates generally to wireless communication systems, including enhancements to aperiodic, semi-persistent, and periodic sounding reference signals for Multi-TRP Coherent Joint Transmission operation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signal flow diagram for flexible cross carrier AP-SRS triggering for multi-TRP coherent joint transmission operation in accordance with one embodiment.

FIG. 2 illustrates a carrier indicator SRS request field divided into multiple parts in accordance with one embodiment.

FIG. 3 illustrates a carrier indicator field that is jointly encoded in accordance with one embodiment.

FIG. 4 illustrates an SRS request field that is duplicated multiple times in accordance with one embodiment.

FIG. 5 illustrates an SRS request field that is jointly encoded in accordance with one embodiment.

FIG. 6 illustrates a method for a network node to trigger an AP-SRS for multi-TRP coherent joint transmission operation in accordance with one embodiment

FIG. 7 illustrates a signal flow diagram for flexible periodic (P) SRS or semi-periodic (SP) SRS activation for multi-TRP coherent joint transmission operation in accordance with one embodiment.

FIG. 8 illustrates a MAC CE to activate an SP-SRS resource set in accordance with one embodiment.

FIG. 9 illustrates how a transmission schedule with a collision between a downlink transmission and a P/SP-SRS is handled by a current NR standard.

FIG. 10 illustrates a transmission schedule where the UE postpones periodic and semi-persistent SRS transmission based on collisions in accordance with one embodiment.

FIG. 11 illustrates a method for a UE to send a P/SP-SRS for multi-TRP coherent joint transmission operation in accordance with one embodiment.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, sounding reference signals (SRS) may be used to estimate uplink channel quality. A wireless communication device or mobile device (i.e., UE) can transmit an SRS to a base station (e.g., eNB for LTE and gNB for NR). SRS gives information about the combined effect of multipath fading, scattering, Doppler and power loss of transmitted signal. Using the SRS, the base station may estimate the channel quality and manage resources accordingly. For example, SRS may provide information to the base station about the resources over a bandwidth. Using this information, the base station may determine which resources have better channel quality and allocate resources accordingly.

In NR Release-15 (Rel-15), a design for the SRS was outlined. Some of the limitations of the SRS design in Rel-15 included that the SRS could only be transmitted in the last six symbols of each slot. Additionally, the SRS could only be repeated for up to four symbols. Rel-15 was also limited to supporting SRS with Comb 1/2/4.

NR Release-16 (Rel-16) provided enhancements for the SRS of Rel-15. In Rel-16, the SRS could be transmitted in any symbol in a slot. Further SRS supported repetition with 8 and 12 symbols. Additionally, in Rel-16 also support SRS with Comb 8.

NR Release-17 (Rel-17) provided further enhancements for SRS. For example, Rel-17 supported flexible aperiodic (AP) SRS triggering. Rel-17 further supported RB-level partial frequency sounding (RPFS). Additionally, the SRS was configured to support repetitions with 10 and 14 symbols. In Rel-17, the SRS also supported Comb 8 with four ports. Channel state information (CSI) feedback in Rel-17 is further enhanced for non-coherent joint transmission (NCJT) for multiple transmission and reception point (TRP) operation (referred to as multi-TRP or mTRP). In certain wireless networks, NCJTs may be used to provide multiple-input multiple-output (MIMO), multiple-user (MU) MIMO, and/or coordinated multi-point (COMP) communications. In Rel-17, CSI feedback for NCJT for multi-TRPs is based on Type I MIMO codebook, which only supports single downlink control information (DCI) multi-TRP NCJT scheme la (i.e., spatial domain multiplexing)).

In certain communication systems (e.g., Rel-18 NR), it may be desirable to provide SRS enhancement for Multi-TRP Coherent Joint Transmission (CJT) operation. To enhance SRS for Multi-TRP CJT operation some embodiments herein use a flexible cross carrier aperiodic SRS (AP-SRS) triggering. Some embodiments include flexible semi-persistent (SP-SRS) activation. Some embodiments include a flexible periodic SRS or SP-SRS transmission. Some embodiments include a flexible SRS resource configuration. Some embodiments include a flexible SRS hopping pattern.

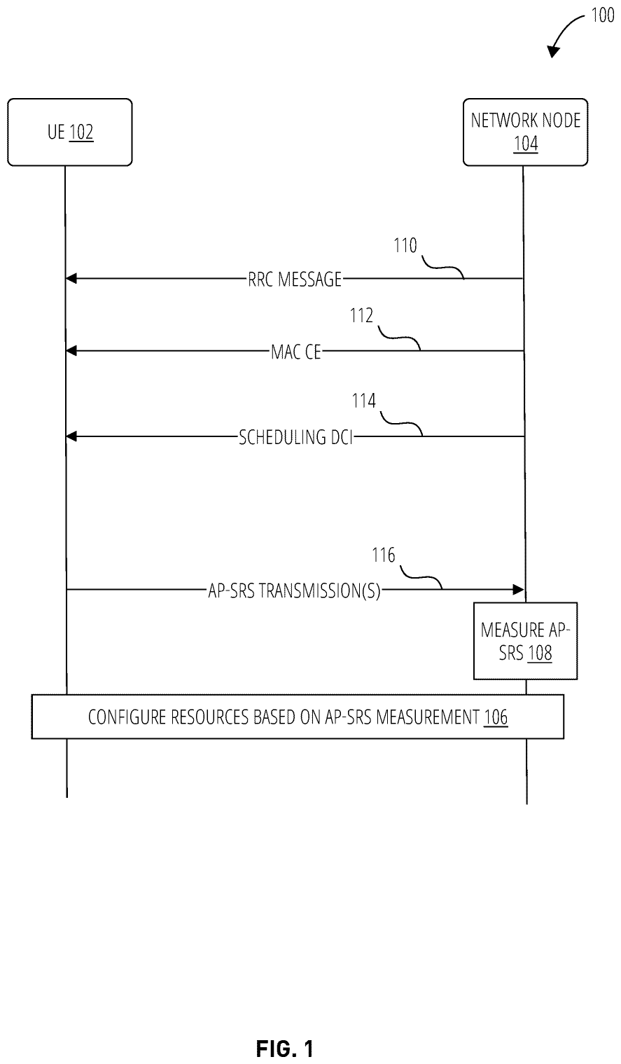

FIG. 1 illustrates a signal flow diagram 100 for flexible cross carrier AP-SRS triggering for multi-TRP coherent joint transmission operation in accordance with one embodiment. The network node 104 may send one or more transmissions to the UE 102 to configure and trigger AP-SRS resources and to trigger AP-SRS transmissions 116. The network node 104 may measure the AP-SRS 108 and coordinate with the UE to configure resources based on AP-SRS measurement 106.

Transmissions from the network node 104 to the UE 102 which may be used for configuration and triggering of the AP-SRS include RRC, MAC CE, and DCI. As shown, the network node 104 may transmit a Radio Resource Control (RRC) message 110 to the UE 102. The network node 104 may also transmit a Medium Access Control Control Element (MAC CE) 112 to the UE 102. The network node 104 may also transmit one or more DCI (e.g., scheduling DCI 114) to the UE 102.

In previous standards, triggering of the AP-SRS for multi-TRP coherent joint transmission operation was limited to one component carrier. If multiple component carriers were desired to be triggered, a DCI for each component carrier was required. Triggering a single component carrier per DCI may introduce additional overhead and additional latency. Embodiments herein provide flexible cross carrier AP-SRS triggering for more than one component carrier for multi-TRP coherent joint transmission operation to support uplink carrier aggregation.

For example, the network node 104 may use scheduling DCI 114 to trigger multiple component carriers for AP-SRS. In some embodiments, in addition to a current SRS indicator field, a new carrier indicator field may be introduced. The new carrier indicator field may allow the network node 104 to schedule a second component carrier in addition to the component carrier scheduled by the previously existing indicator field. This would increase DCI overhead but provide flexible scheduling.

For example, an additional carrier indicator field can be included in the scheduling DCI 114. The scheduling DCI 114 may include the additional carrier indicator field and the original carrier indicator field, thereby providing multiple carrier indicator fields. The additional carrier indicator field may indicate a component carrier in which the UE 102 should transmit the AP-SRS in addition to the component carrier indicated by the original carrier indicator field. While two component carrier indicator fields are discussed, the scheduling DCI 114 may include more component carrier indicator fields if additional component carriers are desired for AP-SRS.

The additional carrier indicator field may be included in one or multiple DCI. For example, the carrier indicator field for the AP-SRS component carrier may be one or more of the DCI Format 0_1, DCI Format 0_2, DCI Format 1_2, DCI Format 1_2. The additional carrier indicator field for the AP-SRS component carrier may contain up to three bits. The mapping of each value of the carrier indicator field to the serving cell ID can be configured by RRC (e.g., RRC message 110).

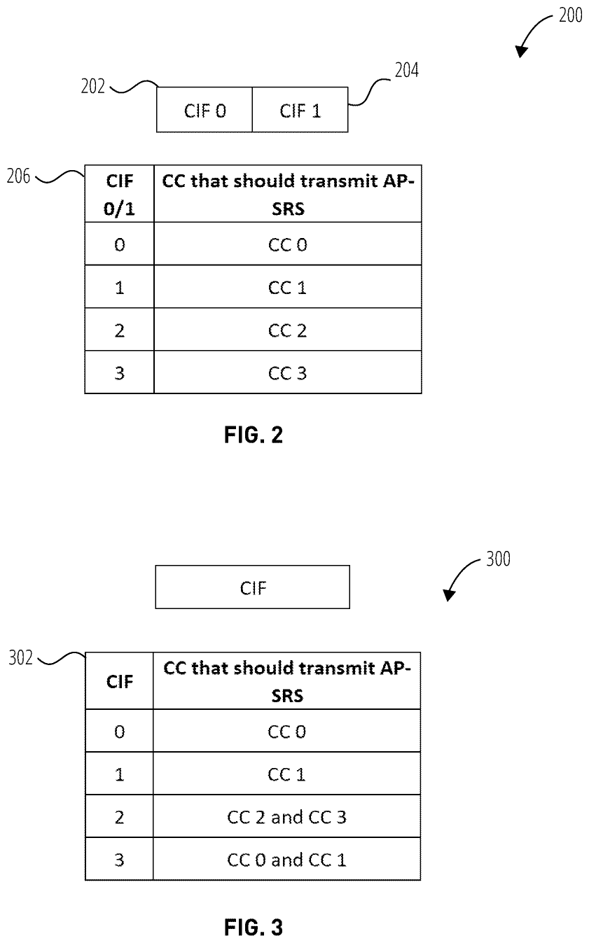

In some embodiments, a carrier indicator field may be enhanced to allow a single DCI (e.g., scheduling DCI 114) to trigger AP-SRS in multiple component carriers simultaneously. FIGS. 2 and 3 illustrate two options for an enhanced carrier indicator field.

FIG. 2 illustrates a carrier indicator field 200 divided into multiple parts (i.e., first portion 202 and second portion 204). Each part indicates a component carrier index independently. In other words, the first portion 202 of the carrier indicator field 200 may indicate a first component carrier index, and the second portion 204 of the carrier indicator field 200 may indicate a second component carrier index. Using multiple portions of the carrier indicator field 300 may allow the network node to trigger transmission of the AP-SRS on multiple component carriers simultaneously.

A mapping table 206 may be configured to indicate which component carrier

should transmit the AP-SRS. In the illustrated embodiment the mapping table 206 indicates that if the first portion 202 or second portion 204 has a value of zero, the UE should use component carrier zero to transmit the AP-SRS. If the first portion 202 or second portion 204 has a value of one, the UE should use component carrier one to transmit the AP-SRS. If the first portion 202 or second portion 204 has a value of two, the UE should use component carrier two to transmit the AP-SRS. If the first portion 202 or second portion 204 has a value of three, the UE should use component carrier three to transmit the AP-SRS.

For example, the network node may generate a DCI with the carrier indicator field 200 and set the first portion 202 to one and the second portion 204 to three. The network node may then transmit the DCI including the carrier indicator field 200 to the UE. The UE may decode the DCI and use component carrier one and component carrier three to transmit the AP-SRS based on the value of first portion 202 and the value of the second portion 204 of the carrier indicator field 200.

FIG. 3 illustrates a carrier indicator field 300 that is jointly encoded. That is, the value of each carrier indicator field 300 may be mapped to a one or more component carriers. The network node may use RRC to configure the mapping table 302. The mapping table 302 indicates a list of component carriers that correspond to the possible values of the carrier indicator field 300. The list of component carriers for each value may include one or more component carriers. Using a single value in the carrier indicator field 300 to indicate multiple component carriers may allow the network node to trigger transmission of the AP-SRS on multiple component carriers simultaneously.

In the illustrated embodiment, the carrier indicator field 300 includes two bits which results in four different possible values. More bits may be used to indicate additional component carrier configurations. In the illustrated embodiment the mapping table 302 indicates that if the value is zero, the UE should use component carrier zero to transmit the AP-SRS. If the value is one, the UE should use component carrier one to transmit the AP-SRS. If the value is two, the UE should use component carrier two and component carrier three to transmit the AP-SRS. If the value is three, the UE should use component carrier zero and component carrier one to transmit the AP-SRS.

For example, the network node may generate a DCI with the carrier indicator field 300 and set the value to two. The network node may then transmit the DCI including the carrier indicator field 300 to the UE. The UE may decode the DCI and use component carrier two and component carrier three to transmit the AP-SRS based on the value of the carrier indicator field 300.

Referring again to FIG. 1, a single DCI (e.g., scheduling DCI 114) can be used to trigger AP-SRS in multiple component carriers simultaneously using multiple carrier indicator fields, multiple portions of a carrier indicator field, and/or a carrier indicator field value mapped to a list of component carriers. When a single DCI is used to trigger AP-SRS in multiple component carriers simultaneously, the network node 104 should indicate whether normal uplink (NUL) or supplemental uplink (SUL) should be used for AP-SRS transmission in each component carrier. The network node 104 may associate a NUL/SUL indication with a corresponding component carrier to provide the UE 102 with an indication of the uplink type.

In a first embodiment, the network node 104 may include one independent bit for each component carrier in the DCI in the carrier indicator field. The bits may indicate to the UE whether NUL or SUL should be used for AP-SRS transmission in each component carrier.

In a second embodiment, the network node 104 may provide one common indication for the component carriers indicated by the DCI in the carrier indicator field. For example, the network node 104 may use a single bit in the DCI to indicate whether NUL or SUL should be used for AP-SRS transmission in all of the component carrier. Further, in some embodiments, for each component carrier, if the common indication is SUL, but the corresponding component carrier does not have SUL, the UE 102 may transmit AP-SRS in the NUL in the corresponding component carrier. For example, if two component carriers were triggered for AP-SRS and the first component carrier has SUL and the second component carrier does not have SUL, the UE 102 may transmit the first component carrier in the SUL and the second component carrier in the NUL. Otherwise, if the common indication is NUL or the corresponding component carriers include SUL when the common indication is SUL, the UE 102 may transmit AP-SRS according to the common indication in the corresponding component carriers.

In some embodiments, the network node 104 may configure one or multiple lists of component carriers via the RRC message 110 or the MAC CE 112. Each list of component carriers may contain one or more component carriers. In some embodiments, an optional restriction may be imposed to prevent each component carrier from belonging to more than one list of component carriers. The lists of component carriers may be used by the UE 102 to determine which component carriers to use to transmit the AP-SRS. For instance, in some embodiments, when the network node 104 triggers an AP-SRS transmission in one component carrier, the UE 102 transmits the AP-SRS in the scheduled component carrier and also transmits a corresponding AP-SRS in other component carriers that belong to the same component carrier list as the scheduled component carrier.

For example, in an embodiment with four component carriers, the network node 104 may provide to the UE 102, via the RRC message 110 or the MAC CE 112, two lists of component carriers. The first list of component carriers may contain component carrier zero and component carrier one, and the second list of component carriers may contain component carrier two and component carrier three. The network node 104 may transmit the scheduling DCI 114 to the UE 102. The scheduling DCI 114 may include a component carrier field for AP-SRS that indicates component carrier zero. The UE 102 may check the lists of component carriers and identify that component carrier zero is in the first list with component carrier one. The UE 102 may then send AP-SRS transmissions 116 in both component carrier zero and component carrier one.

Each component carrier may correspond to multiple AP-SRS states. The network node 104 can indicate which AP-SRS state the UE 102 should use when transmitting the AP-SRS transmissions 116. The network node 104 may indicate the AP-SRS state using a DCI. In addition to being able to use a single DCI (e.g., scheduling DCI 114) to trigger multiple component carriers using any of the above embodiments, the single DCI can be configured to trigger multiple AP-SRS trigger states simultaneously.

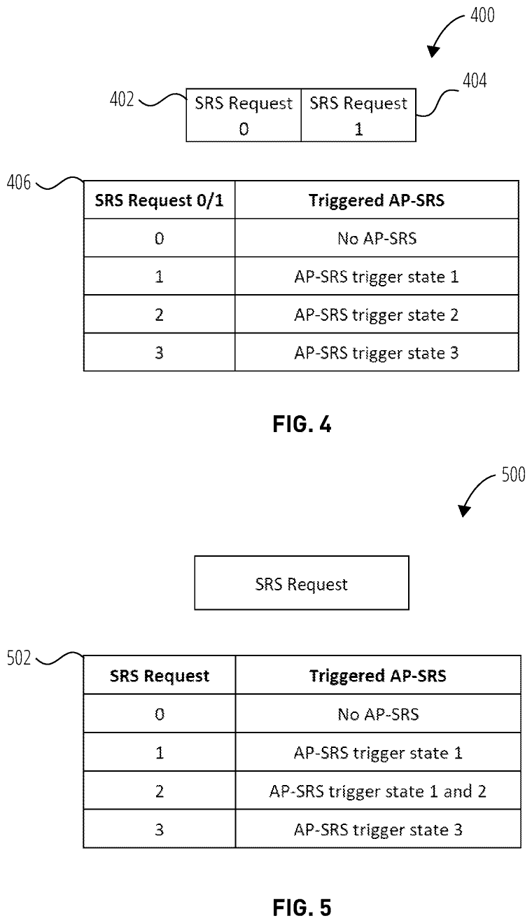

In some embodiments, an SRS request field may be enhanced to allow a single DCI to trigger multiple AP-SRS states simultaneously. FIG. 4 and FIG. 5 illustrate two options for an enhanced SRS request field.

FIG. 4 illustrates an SRS request field 400 that is duplicated multiple times (e.g., first SRS request field 402 and second SRS request field 404). Each duplicated SRS request field 400 indicates an AP-SRS trigger state independently. In other words, the first SRS request field 402 may indicate a first AP-SRS trigger state, and the second SRS request field 404 may indicate a second AP-SRS trigger state. In some embodiments, the AP-SRS trigger states may be used for multiple component carriers scheduled by the DCI. In some embodiments, the network node 104 may indicate which AP-SRS trigger state(s) should be used for individual component carriers scheduled by the DCI.

A mapping table 406 may be configured to indicate which AP-SRS trigger state should be used. In the illustrated embodiment the mapping table 406 indicates that if the first SRS request field 402 or second SRS request field 404 has a value of zero, there is no AP-SRS corresponding to that field. If the first SRS request field 402 or second SRS request field 404 has a value of one, the UE should use AP-SRS trigger state one. If the first SRS request field 402 or second SRS request field 404 has a value of two, the UE should use AP-SRS trigger state two. If the first SRS request field 402 or second SRS request field 404 has a value of three, the UE should use AP-SRS trigger state three.

FIG. 5 illustrates an SRS request field 500 that is jointly encoded. That is, the value of the SRS request field 500 may be mapped to a one or more AP-SRS trigger states. The network node may use RRC to configure the mapping table 502. The mapping table 502 indicates a list of AP-SRS trigger states that correspond to the possible values of the SRS request field 500. The list for each value may include one or more AP-SRS trigger states. Using a single value in the SRS request field 500 to indicate multiple AP-SRS trigger states may allow the network node to trigger transmission using multiple AP-SRS trigger states simultaneously.

In the illustrated embodiment, the SRS request field 500 includes two bits which results in four different possible values. More bits may be used to indicate additional AP-SRS trigger state configurations. In the illustrated embodiment the mapping table 502 indicates that if the value is zero, there is no AP-SRS. If the value is one, the UE should use AP-SRS trigger state one. If the value is two, the UE should use AP-SRS trigger state one and AP-SRS trigger state two. If the value is three, the UE should use AP-SRS trigger state three.

Referring again to FIG. 1, the configuration of the AP-SRS transmissions 116 may also be enhanced by using flexible SRS resource configuration. In some embodiments, for AP-SRS resource set the network node 104 may configure different SRS resources in different slots in a same AP-SRS resource set. For example, the SRS-Resource configuration may include a slotOffset integer as shown below to indicate the different slots.

```
resourceType CHOICE {
  aperiodic SEQUENCE {
    slotOffset INTEGER (0..31),
...
  },
  semi-persistent SEQUENCE {
    periodicityAndOffset-sp SRS-PeriodicityAndOffset,
    ...
  },
  periodic SEQUENCE {
    periodicityAndOffset-p SRS-PeriodicityAndOffset,
    ...
  }
},
```

Using the slotOffset would allow the AP-SRS to span multiple slots. This would allow the UE 102 and network node 104 more scheduling flexibility than if the AP-SRS was limited to a single slot. Similarly, for SRS resource configuration (i.e., SRS-Resource) when a SRS resource contains repetition of more than one symbol, the SRS resource may be allowed to cross slot boundary. The scheduling flexibility may help with scheduling multiple AP-SRS transmissions to support AP-SRS for multi-TRP coherent joint transmission operation.

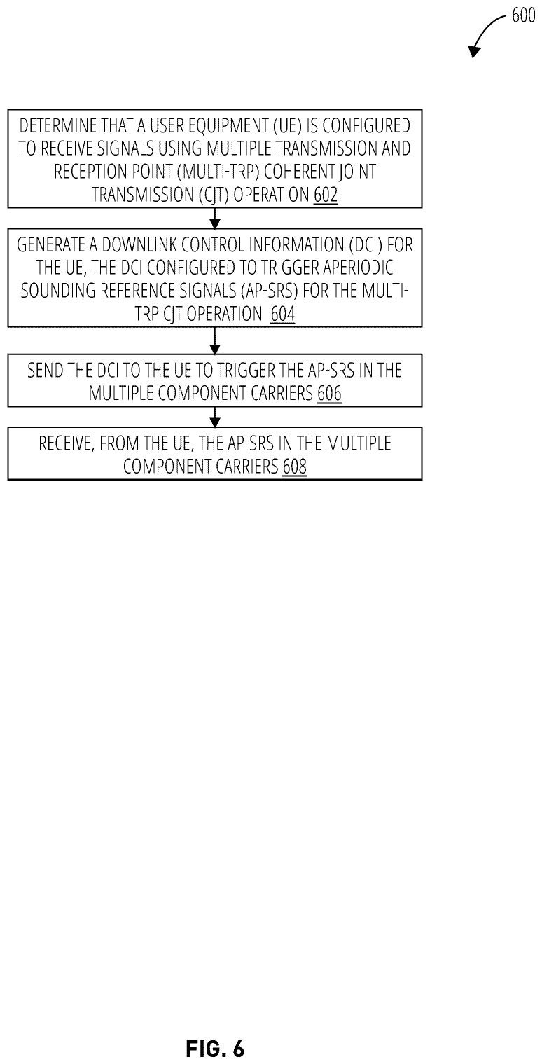

FIG. 6 illustrates a method 600 for a network node to trigger an AP-SRS for multi-TRP coherent joint transmission operation in accordance with one embodiment. In the illustrated embodiment, the network node determines 602 that a UE is configured to receive signals using Multi-TRP CJT operation. The network node may generate 604 a DCI for the UE, the DCI configured to trigger aperiodic sounding reference signals (AP-SRS) for the Multi-TRP CJT operation. The DCI may comprise an indication that identifies multiple component carriers on which the UE should transmit AP-SRS. The network node may send 606 the DCI to the UE to trigger the AP-SRS in the multiple component carriers, and receive 608, from the UE, the AP-SRS in the multiple component carriers.

In some embodiments, the indication that identifies multiple component carriers comprises multiple carrier indicator fields in the DCI. In some embodiments, the indication that identifies multiple component carriers comprises a carrier indicator field divided into multiple parts, wherein each part of the carrier indicator field independently identifies one of the multiple component carriers. In some embodiments, the indication that identifies multiple component carriers comprises a carrier indicator field where a value of the carrier indicator field is mapped to a list of component carriers. In some embodiments, the DCI further comprises independent one bit indications for each component carrier indicating whether normal UL or supplemental UL should be used for the AP-SRS transmission in each component carrier. In some embodiments, the network node may further configure one or more lists of component carriers, wherein each list comprises one or more component carriers, wherein the indication that identifies multiple component carriers comprises a value corresponding to one component carrier to indicate to the UE to use all component carriers on a list comprising the one component carrier for the AP-SRS transmission. In some embodiments, the DCI further comprises multiple SRS request fields to trigger multiple AP-SRS trigger states. In some embodiments, the network node may further configure different SRS resources in different slots in the same AP-SRS resource set. In some embodiments, the DCI further comprises an SRS request field where a value of the SRS request field is mapped to a list of AP-SRS trigger states. In some embodiments, an SRS resource is allowed to cross a slot boundary.

Embodiments contemplated herein include an apparatus comprising means to perform one or more elements of the method 600. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 600. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 1318 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

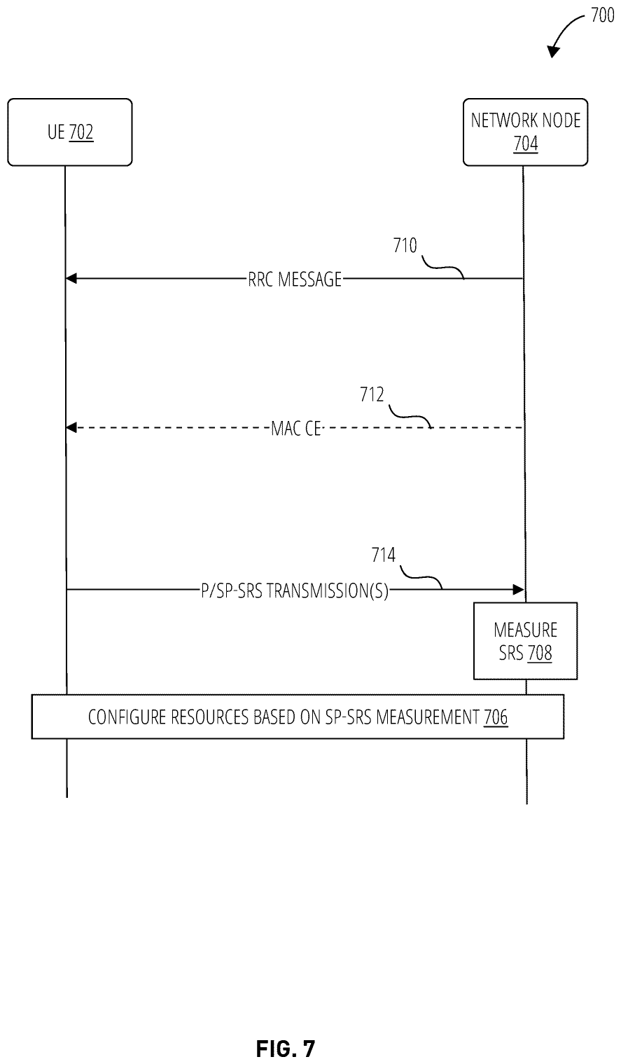

FIG. 7 illustrates a signal flow diagram 700 for flexible periodic (P) SRS or semi-periodic (SP) SRS activation for multi-TRP coherent joint transmission operation in accordance with one embodiment. The P-SRS is a reference signal that is RRC configured and occurs periodically (e.g., every 20 milliseconds). The SP-SRS is a reference signal that is RRC configured and periodically transmitted when activated by a MAC-CE.

For example, for P-SRS, the network node 704 may transmit an RRC message 710 to the UE 702. The RRC message 710 may include configuration details that may be used by the receiving UE 702 to determine resources to use for the P-SRS (e.g., P/SP-SRS transmissions 714).

Similarly, for SP-SRS, the network node 704 may transmit an RRC message 710 to the UE 702. The RRC message 710 may include configuration details for a SP-SRS. The UE 702 may then wait for the network node 704 to send a MAC CE 712 to activate the SP-SRS. When activated the UE 702 may transmit SP-SRS (e.g., P/SP-SRS transmissions 714).

The network node 704 may measure the SRS 708 to determine channel state information. The network node 704 and the UE 702 may then configure resources based on SP-SRS measurement 706. The SP-SRS and P-SRS configurations and activation may be enhanced to reduce overhead and latency for multi-TRP coherent joint transmission operation.

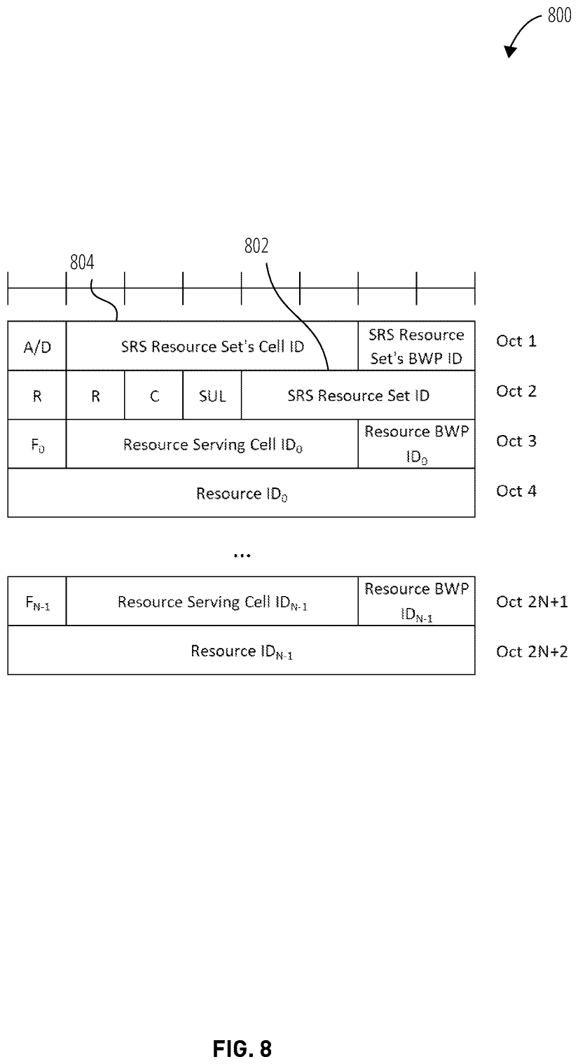

For example, FIG. 8 illustrates a MAC CE 800 to activate an SP-SRS resource set in accordance with one embodiment. In the current standard, a single MAC CE 800 can be used to activate only one SRS resource set in one component carrier. The SRS resource set to be activated can be indicated by SRS Resource Set ID field 802. Further, the component carrier can be indicated by SRS Resource Set's Cell ID field 804.

According to the current standard, if the network node desires to activate SRS in multiple component carriers or trigger multiple SRS resource sets, the network will have to send multiple MAC CEs. This will result in a higher overhead and greater processing latency than a single MAC CE.

Embodiments herein provide an enhanced MAC CE for flexible SP-SRS activation. The enhanced MAC CE may activate SRS in multiple component carriers simultaneously. Further, some embodiments may be configured to activate multiple SRS resource sets within each component carrier using a single MAC CE.

For example, a single enhanced MAC CE can be used to perform one or both of activating multiple SP-SRS component carriers and activating multiple SP-SRS resource sets. For example, the MAC CE may activate SP-SRS resource set in different component carriers simultaneously. In some embodiments, the network node may generate a MAC CE with multiple SRS Resource Set's Cell ID fields. In other words, multiple SRS Resource Set's Cell ID fields can be configured in the same MAC CE. Further, the MAC CE may activate multiple SP-SRS resource set in the same component carriers simultaneously. In some embodiments, the network node may configure multiple SRS Resource Set ID fields in a single MAC CE. When the UE receives the MAC CE, it can determine the component carriers based on the SRS Resource Set's Cell ID fields, and determine resources sets to use for SP-SRS based on the SRS Resource Set ID fields.

In some embodiments, a network node may configure multiple component carriers for activation using a single non-enhanced MAC-CE (e.g., MAC CE 800) at the RRC level. For example, the network node may generate an RRC message comprising one or multiple lists of component carriers to send to the UE. Each list of component carriers may include one or more component carriers. The component carriers in each list are considered to correspond with each other such that an activation of one component carrier on a list causes an activation of all component carriers on the same list. In some embodiments, an optional restriction may be imposed to prevent each component carrier from belonging to more than one list of component carriers.

For example, a network node may send an RRC message to a UE with one or more lists of component carriers. The network node may also send the MAC CE 800 to a UE. The UE may determine that the SRS Resource Set's Cell ID field 804 activates SP-SRS transmission in one component carrier. The UE may identify component carriers on the same list as the one component carrier identified in the SRS Resource Set's Cell ID field 804. The UE may activate the SP-SRS transmission in the component carrier identified in the SRS Resource Set's Cell ID field 804 and also activate the corresponding SP-SRS transmission in the other component carriers that belong to the same component carrier list as the component carrier indicated by the MAC CE.

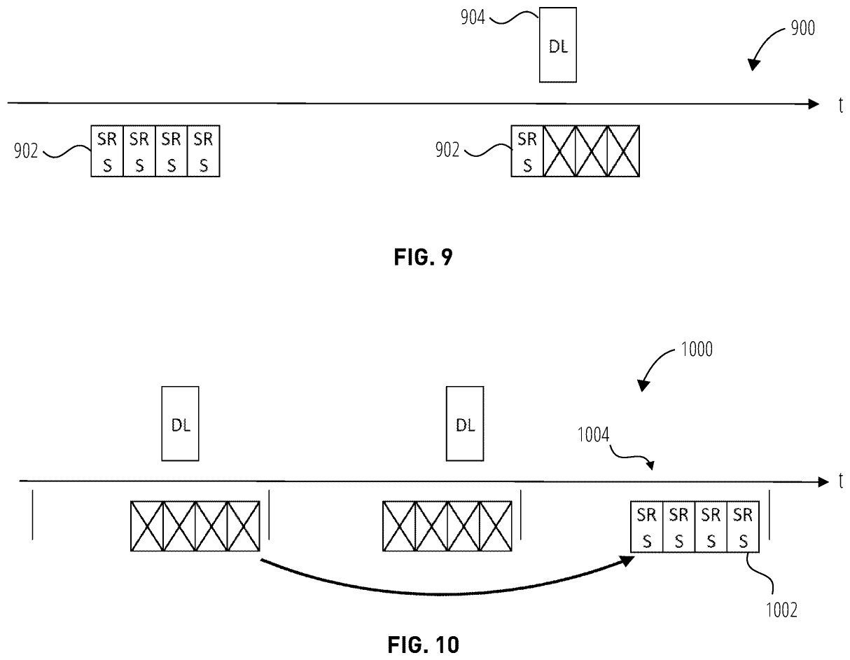

FIG. 9 illustrates how a transmission schedule 900 with a collision between a downlink transmission 904 and a P/SP-SRS 902 is handled by a current NR standard. As shown, a UE may send a periodic or semi periodic (P/SP) SRS 902 transmission during a first time period without conflict. The P/SP-SRS 902 may have four symbol repetition. During a second time period, the UE may again transmit the P/SP-SRS 902.

However, during the second time period, the downlink transmission 904 collides with the second symbol of the SRS. As shown, when periodic and semi-persistent SRS (e.g., P/SP-SRS 902) transmissions experience a collision (for example, due to duplex direction conflict), the P/SP-SRS is cancelled and dropped. In the illustrated embodiment, because the second symbol collides with the downlink transmission 904, the second symbol and all remaining symbol repetitions in the P/SP-SRS 902 are canceled resulting in a partial cancelation of the P/SP-SRS 902. This partial cancelation may result in a loss of coverage resulting in a less reliable SRS. The collisions may be difficult to avoid for periodic and semi-persistent SRS due to their periodic nature.

In some embodiments, flexible P-SRS and SP-SRS transmissions (e.g., P/SP-SRS transmissions 714) may be used to support multi-TRP coherent joint transmission operation. For example, FIG. 10 illustrates a transmission schedule 1000 where the UE postpones periodic and semi-persistent SRS (e.g., P/SP-SRS 1002) transmission based on collisions.

In this embodiment, when the P/SP-SRS 1002 transmission is expected to be dropped, the P/SP SRS transmission may be postponed to the earliest next available slot (e.g., slot 1004). If before the next P/SP SRS resource set transmission slot, there is no available slot, the P/SP-SRS 1002 is dropped completely.

The UE may transmit the P/SP SRS again according to the SRS periodicity. During each cycle of the SRS periodicity, the UE may attempt to send the entire P/SP-SRS 1002 transmission as discussed above. That is, if the transmission is expected to be dropped (e.g., collide with a downlink transmission), the UE postpones the P/SP-SRS 1002 to the earliest slot that does not include a collision, and if there isn't an available slot before the next P/SP SRS resource set transmission slot, the UE drops the P/SP-SRS 902 during that period.

Postponing the SRS would allow the UE to transmit the whole SRS making the SRS more reliable. Further, the ability to postpone the SRS transmission adds flexibility to the periodic nature of the P/SP-SRS 1002.

Collision detection by the UE may be based on RRC configuration. For example, in some embodiments, the determination, by the UE, of whether a slot is available may be solely based on the RRC configuration, not based on the semi-static MAC CE or the dynamic DCI indication. For example, the RRC configured slot format may be in terms of which symbol is for downlink operation and which symbol is for uplink operation. The UE may check the RRC configuration to determine where the downlink symbols are to ensure sufficient time for the P/SP-SRS 1002 transmission.

Additionally, in some embodiments, the UE may determine whether a slot is available based on the severity of the collision. For example, in a first option, if any SRS resource in the SRS resource set has a collision the UE postpones the P/SP-SRS 1002. In a second option, if all SRS resources in the SRS resource set has a collision the UE postpones the P/SP-SRS 1002. A wireless communication system may support one or both of the two options. For example, in a wireless communication system supporting both options, the UE may indicate its capability and the network node may indicate which option the network prefers.

In some embodiments, a flexible SRS hopping pattern may be used to minimize interference using interference randomization. For periodic and a semi-persistent SRS (e.g., P/SP-SRS transmissions 714), interference can become persistent when nearby UEs transmit with the same periodicity. Interference randomization may reduce the likelihood of interference becoming persistent. With randomization, even if a first SRS transmission causes interference between UEs, interference is unlikely to happen during the next SRS transmission.

Interference randomization may be accomplished in a variety of ways. In some embodiments, randomization of SRS sequence ID (i.e., sequenceId field in the SRS-Resource configuration) may occur. The randomization of the SRS sequence ID may cause the UE to transmit using a different sequence each interval of the SRS periodicity. The sequence randomization may be configured between the UE and the network node. For example, the network node to send a predetermined randomization for the sequence ID to the UE.

In some embodiments, the comb configuration (i.e., transmissionComb in SRS-Resource configuration) may be randomized. The comb size may remain the same, but the comb offset and cyclic shift may change each interval of the SRS periodicity. The network node may configure the comb size and offset. For example, the network node may segment the resources into comb 4. For each interval of the SRS periodicity there may be a different offset and/or cyclic shift. The offset and/or cyclic shift randomization may be configured between the UE and the network node. For example, the network node to send a predetermined randomization for the offset and/or cyclic shift to the UE.

In some embodiments, the time domain location (i.e., resourceMapping in SRS-Resource configuration) of the SRS within a slot may be randomized every period. For example, the starting symbol of the SRS may change each interval of the periodicity. The time domain randomization may be configured between the UE and the network node. For example, the network node to send a predetermined randomization for the time domain to the UE.

In some embodiments, quasi colocation (QCL) (i.e., spatialRelationInfo in SRS-Resource configuration) may be randomized. The QCL randomization may be configured between the UE and the network node. For example, the network node to send a predetermined randomization for the QCL to the UE.

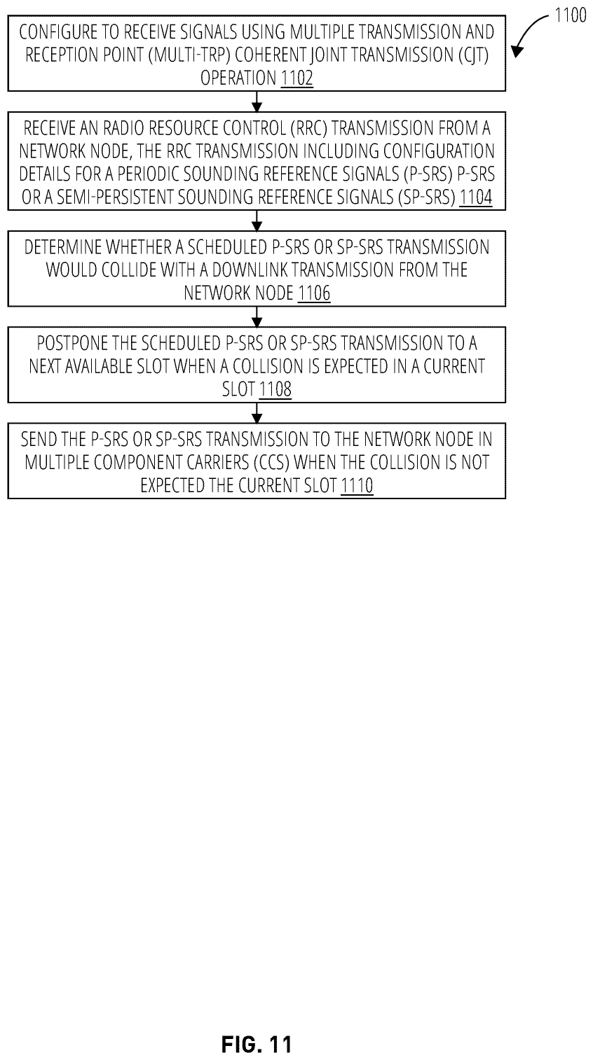

FIG. 11 illustrates a method for a UE to send a P/SP-SRS for multi-TRP coherent joint transmission operation in accordance with one embodiment. The UE may configure 1102 to receive signals using Multi-TRP CJT operation. The UE may receive 1104 an RRC transmission from a network node, the RRC transmission including configuration details for a P-SRS or a SP-SRS. The UE may determine 1106 whether a scheduled P-SRS or SP-SRS transmission would collide with a downlink transmission from the network node. The UE may postpone 1108 the scheduled P-SRS or SP-SRS transmission to a next available slot when a collision is expected in a current slot. The UE may send 1110 the P-SRS or SP-SRS transmission to the network node in one or multiple CCs when the collision is not expected the current slot.

In some embodiments, if there is no available slot before a next scheduled P-SRS or SP-SRS transmission, dropping the scheduled P-SRS or SP-SRS transmission. In some embodiments, the method further comprises receiving a MAC CE from the network node, wherein the MAC CE activates one or both of: an SP-SRS resource set in different CCs simultaneously, and multiple SP-SRS resource sets in a same CC simultaneously. In some embodiments, the MAC CE comprises one or both of: multiple SRS resource set's Cell ID fields, and multiple SRS Resource Set ID fields. In some embodiments, the RRC transmission further comprises one or more lists of CCs, wherein each list comprises one or more CCs, wherein the MAC CE includes one CC, wherein the UE uses all CCs on a list comprising the one CC from the MAC CE for the SP-SRS transmission. In some embodiments, determining the collision is based on RRC configuration. In some embodiments, the current slot is not available for the P-SRS or SP-SRS transmission if any SRS resource in the SRS resource set are affected by the collision. In some embodiments, the current slot is not available for the P-SRS or SP-SRS transmission only if all SRS resource in the SRS resource set are affected by the collision. In some embodiments, the method further comprises randomizing an SRS sequence used for sending the P-SRS or SP-SRS transmission to the network node. In some embodiments, the method further comprises randomizing a comb offset or cyclic shift used for sending the P-SRS or SP-SRS transmission to the network node.

Embodiments contemplated herein include an apparatus comprising means to perform one or more elements of the method 1100. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the method 1100. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1302 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

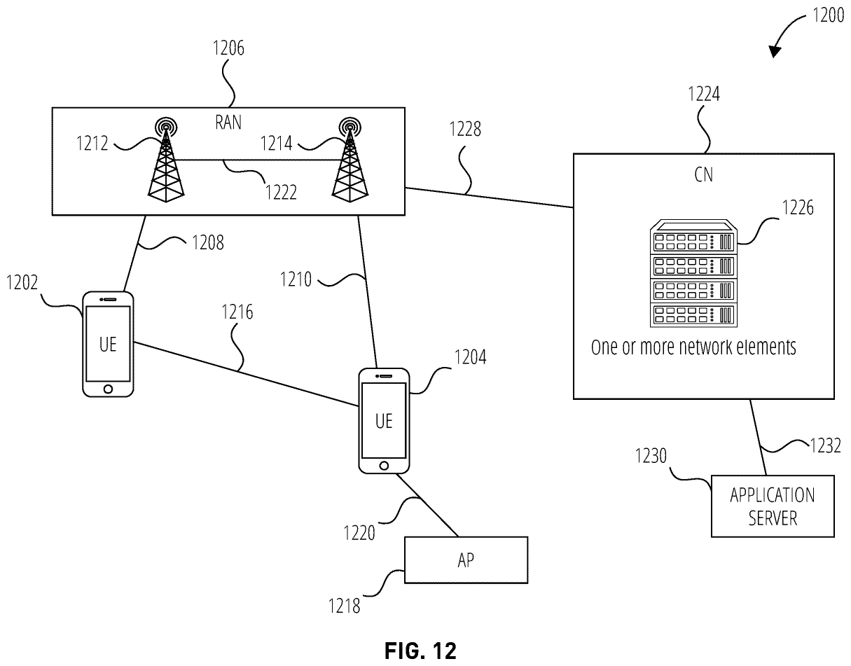

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations, such as base station 1212 and base station 1214, that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VOIP sessions, group communication sessions, etc.) for the UE 1202 and UE 1204 via the CN 1224. The application server 1230 may communicate with the CN 1224 through an IP communications interface 1232.

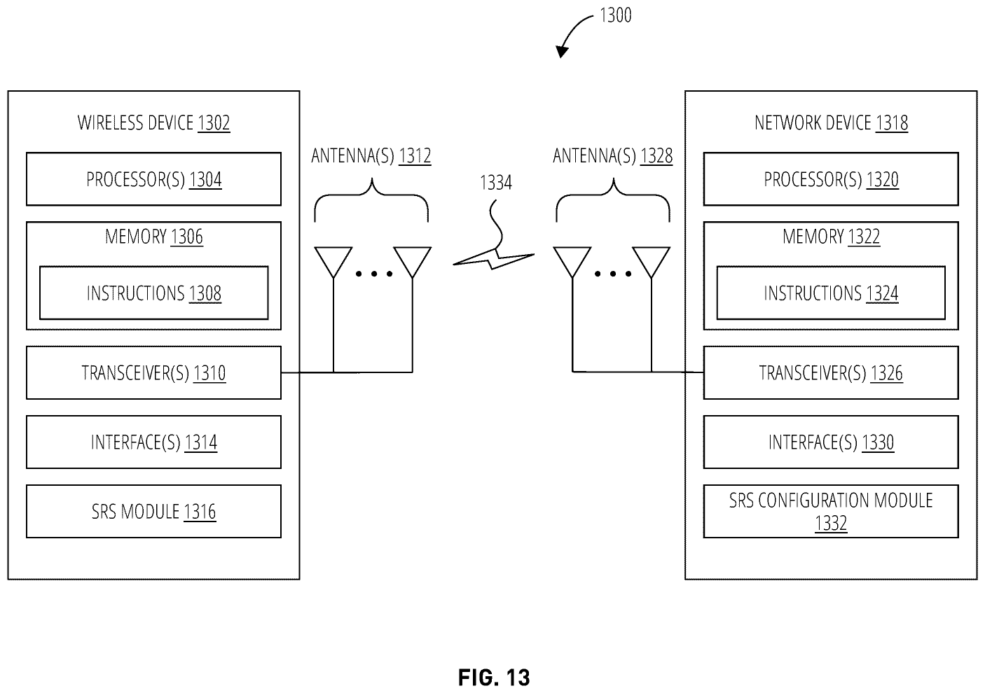

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include an SRS module 1316. The SRS module 1316 may be implemented via hardware, software, or combinations thereof. For example, the SRS module 1316 may be implemented as a processor, circuit, and/or instructions 1308 stored in the memory 1306 and executed by the processor(s) 1304. In some examples, the SRS module 1316 may be integrated within the processor(s) 1304 and/or the transceiver(s) 1310. For example, the SRS module 1316 may be implemented by a combination of software components (e.g., executed by a DSP or a general processor) and hardware components (e.g., logic gates and circuitry) within the processor(s) 1304 or the transceiver(s) 1310.

The SRS module 1316 may be used for various aspects of the present disclosure, for example, aspects of FIGS. 1-12. The SRS module 1316 is configured to send a SRS based on configurations from the network device 1318.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto

The network device 1318 may include an SRS configuration module 1332. The SRS configuration module 1332 may be implemented via hardware, software, or combinations thereof. For example, the SRS configuration module 1332 may be implemented as a processor, circuit, and/or instructions 1324 stored in the memory 1322 and executed by the processor(s) 1320. In some examples, the SRS configuration module 1332 may be integrated within the processor(s) 1320 and/or the transceiver(s) 1326. For example, the SRS configuration module 1332 may be implemented by a combination of software components (e.g., executed by a DSP or a general processor) and hardware components (e.g., logic gates and circuitry) within the processor(s) 1320 or the transceiver(s) 1326.

The SRS configuration module 1332 may be used for various aspects of the present disclosure, for example, aspects of FIGS. 1-12. The SRS configuration module 1332 is configured to configure SRS transmissions from the UE.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
determining that a user equipment (UE) is configured to receive signals using multiple transmission and reception point (Multi-TRP) Coherent Joint Transmission (CJT) operation;
generating a downlink control information (DCI) for the UE, the DCI configured to trigger aperiodic sounding reference signals (AP-SRS) for the Multi-TRP CJT operation,
wherein the DCI comprises an indication that identifies multiple component carriers (CCs) on which the UE should transmit the AP-SRS;
sending the DCI to the UE to trigger the AP-SRS in the multiple component carriers; and
receiving, from the UE, the AP-SRS in the multiple component carriers.

2. The method of claim 1, wherein the indication that identifies multiple CCs comprises multiple carrier indicator fields in the DCI.

3. The method of claim 1, wherein the indication that identifies multiple CCs comprises a carrier indicator field divided into multiple parts, wherein each part of the carrier indicator field independently identifies one of the multiple CCs.

4. The method of claim 1, wherein the indication that identifies multiple CCs comprises a carrier indicator field where a value of the carrier indicator field is mapped to a list of CCs.

5. The method of claim 1, wherein the DCI further comprises independent one bit indications for each CC indicating whether normal UL or supplemental UL should be used for the AP-SRS transmission in each CC.

6. The method of claim 1, further comprising configuring one or more lists of CCs, wherein each list comprises one or more CCs, wherein the indication that identifies multiple CCs comprises a value corresponding to one CC to indicate to the UE to use all CCs on a list comprising the one CC for the AP-SRS transmission.

7. The method of claim 1, wherein the DCI further comprises multiple SRS request fields to trigger multiple AP-SRS trigger states.

8. The method of claim 1, wherein the DCI further comprises an SRS request field where a value of the SRS request field is mapped to a list of AP-SRS trigger states.

9. The method of claim 1, further comprising configuring different SRS resources in different slots in a same AP-SRS resource set.

10. The method of claim 1, wherein an SRS resource is allowed to cross a slot boundary.

11. A method for a UE, the method comprising:
configuring to receive signals using multiple transmission and reception point (Multi-TRP) Coherent Joint Transmission (CJT) operation;
receiving a Radio Resource Control (RRC) transmission from a network node, the RRC transmission including configuration details for a periodic sounding reference signals (P-SRS) or a semi-persistent sounding reference signals (SP-SRS),
determining whether a scheduled P-SRS or SP-SRS transmission would collide with a downlink transmission from the network node;
postponing the scheduled P-SRS or SP-SRS transmission to a next available slot when a collision is expected in a current slot; and
sending the P-SRS or SP-SRS transmission to the network node in one or multiple component carriers (CCs) when the collision is not expected in the current slot.

12. The method of claim 11, if there is no available slot before a next scheduled P-SRS or SP-SRS transmission, dropping the scheduled P-SRS or SP-SRS transmission.

13. The method of claim 11, further comprising receiving a Medium Access Control Control Element (MAC CE) from the network node, wherein the MAC CE activates one or both of:
an SP-SRS resource set in different CCs simultaneously, and
multiple SP-SRS resource sets in a same CC simultaneously.

14. The method of claim 13, wherein the MAC CE comprises one or both of:
multiple SRS resource set's Cell ID fields, and
multiple SRS Resource Set ID fields.

15. The method of claim 13, wherein the RRC transmission further comprises one or more lists of CCs, wherein each list comprises one or more CCs, wherein the MAC CE includes one CC, wherein the UE uses all CCs on a list comprising the one CC from the MAC CE for the SP-SRS transmission.

16. The method of claim 11, wherein determining the collision is based on RRC configuration.

17. The method of claim 11, wherein the current slot is not available for the P-SRS or SP-SRS transmission if any SRS resource in the SRS resource set are affected by the collision.

18. The method of claim 11, wherein the current slot is not available for the P-SRS or SP-SRS transmission only if all SRS resource in the SRS resource set are affected by the collision.

19. The method of claim 11, further comprising randomizing an SRS sequence used for sending the P-SRS or SP-SRS transmission to the network node.

20. The method of claim 11, further comprising randomizing a comb offset or cyclic shift used for sending the P-SRS or SP-SRS transmission to the network node.

21-23. (canceled)
